(19) United States
(12) Patent Application Publication
(10) Pub. No.: US 2025/0122914 A1
(43) Pub. Date: Apr. 17, 2025

(54) ELECTROMECHANICAL DRUM BRAKE

(71) Applicant: Robert Bosch GmbH, Stuttgart (DE)

(72) Inventors: Juergen Hilzinger, Renningen (DE); Laszlo Boros, Ludwigsburg (DE); Rainer Walter, Pleidelsheim (DE); Simon Peter, Weil Der Stadt (DE)

(21) Appl. No.: 18/813,511

(22) Filed: Aug. 23, 2024

(30) Foreign Application Priority Data
Oct. 17, 2023 (DE) 10 2023 210 161.0

(51) Int. Cl. F16D 65/09; F16D 65/40

(52) U.S. Cl. CPC F16D 65/09; F16D 65/40

(57) ABSTRACT

An electromechanical drum brake for a motor vehicle. The electromechanical drum brake includes a drum, in which brake shoes are arranged, and an adjusting device, which is arranged between the brake shoes and driven by a drive unit and via which the brake shoes can be spread for braking. An end of each brake shoe that faces the adjusting device is supported on a support element cooperating with the adjusting device, movably in relation to the support element, wherein a spreading force of the adjusting device is transferable to the brake shoes via the support element.

### CROSS REFERENCE

The present application claims the benefit under 35 U.S.C. § 119 of German Patent Application No. DE 10 2023 210 161.0 filed on Oct. 17, 2023, which is expressly incorporated herein by reference in its entirety.

### FIELD

The present invention relates to an electromechanical drum brake for a motor vehicle.

### BACKGROUND INFORMATION

In today's vehicles, drum brakes with various types of actuation are available. In cars, the drum brakes are typically actuated hydraulically. In this case, hydraulic pressure is built up in a double piston, which is thereby expanded, whereby a force acts on each brake shoe of the drum brake. Since the pistons are guided axially, slightly eccentric force introduction on the piston surface is relatively unproblematic. The brake shoes are therefore often only roughly positioned by a support bearing and by return springs and can find their position within the drum depending on tolerances and the wear state itself.

In trucks, actuation by rotating an S-shaped cam is a widely used form of actuation. In this case, a cam firmly mounted on the backplate is rotated by a defined angle by pneumatic actuation, whereby the shoes are spread. In this type of actuation, the necessary torque as well as the force direction of the contact force depend directly on the position of the rollers, which transfer the force to the shoes. Since the lever arm with which the contact force acts on the cam is kept as small as possible in order to keep the necessary torque low, small position changes of the shoes and of the associated rollers strongly affect the actuation torque. Such brakes are therefore generally designed such that the brake shoes are supported on a pivot bearing, whereby consistent kinematics of the cam/roller mechanism is ensured, regardless of wear and tolerances.

U.S. Pat. No. 10,001,186 B2 describes a drum brake assembly with a drum in which two brake shoes are arranged. At one end, the brake shoes are pivotally connected to one another. An S-shaped cam is arranged between a second end of the brake shoes and spreads apart the brake shoes by rotation so that they engage with the drum and a braking effect is achieved. A shaft of the cam is driven via an electric motor. The electric motor may be connected to the shaft via a planetary gear train, a worm gear train, or directly.

An object of the present invention is to provide an electromechanical drum brake for a motor vehicle, with which out-of-roundness and eccentricity of the drum brake can be compensated and which has low mechanical complexity.

The object may be achieved by an electromechanical drum brake for a motor vehicle according to features of the present invention. Preferred embodiments of the present invention are disclosed herein.

### SUMMARY

The present invention provided an electromechanical drum brake for a motor vehicle. According to an example embodiment of the present invention, the electromechanical drum brake comprises a drum, in which brake shoes are arranged, and an adjusting device, which is arranged between the brake shoes and driven by a drive unit and via which the brake shoes can be spread for braking. An end of each brake shoe that faces the adjusting device is supported on a support means cooperating with the adjusting device, movably in relation to the support means, wherein a spreading force of the adjusting device is transferable to the brake shoes via the support means.

The adjusting device is a device with which a force can be applied to the brake shoes so that they are placed against a drum. The adjusting device is preferably arranged at an upper end of the brake shoes. Preferably, the drive unit comprises an electric motor. According to an example embodiment of the present invention, the spreading force is not applied directly by the adjusting device to the brake shoes, but rather to a support means. Thus, only the support means must abut firmly against the adjusting device. Accordingly, the brake shoes do not abut firmly against the adjusting device. The brake shoes are only supported on the support means. The support means and the brake shoes are thus not fixedly connected to one another so that the brake shoes can move in relation to the support means and can assume the optimal position in the drum during the braking operation. As a result, out-of-roundness and eccentricity of the drum brake can be compensated. This also results in more even wear of the brake shoes. A complex mechanical design for compensating for out-of-roundness and eccentricity can be dispensed with as a result.

In a preferred embodiment of the present invention, a support bearing, on which the brake shoes are movably supported, is arranged at an end of the brake shoes that is opposite to the adjusting device. Such a support bearing is usually already provided in a drum brake. The brake shoes are also movable in relation to this support bearing. Accordingly, the brake shoes are not fixed in the drum so that they can move during a braking operation and can thus compensate for the eccentricity.

In a further preferred embodiment of the present invention, the support means are designed as semi-annular expansion clips. By forming the support means as semi-annular expansion clips, a material requirement for forming the support means can be kept low. The additional weight required by the support means can thereby be reduced.

Preferably, a support bearing, on which the expansion clips are rotatably supported, is arranged at an end of the brake shoes that is opposite to the adjusting device. Such a support bearing is usually already provided in a drum brake. As a result, no additional components are required to rotatably support the expansion clips. A weight of the drum brake can thereby be kept low.

In an advantageous development of the present invention, at least one holding element, which cooperates with the corresponding expansion clip and via which the brake shoes can be held in a normal direction of the drum, is attached to the brake shoes. The holding element is not rigidly fixed to the expansion clips. The brake shoe, along with the holding element, can thus move relative to the expansion clip. The holding element causes the brake shoe not to move in the normal direction in the drum.

Advantageously, the holding element is designed as a retaining clip. Such a retaining clip can be designed as a simple sheet metal part. A manufacturing effort and a weight for the holding element are thus kept low.

According to an expedient embodiment of the present invention, at an expansion clip end facing the cam, the expansion clips respectively comprise a roller carrier, on which a roller is arranged, which is in contact with the cam. The roller rolls on a surface of the cam. By using roller carriers, to which rollers are fastened, a rotational resistance of the adjusting device can thus be reduced. As a result, the adjusting device can spread the brake shoes with a lower torque. Accordingly, an electric motor for driving the adjusting device can be smaller and thus also lighter.

Advantageously, according to an example embodiment of the present invention, the adjusting device is designed as an S-shaped cam. The use of such a cam has the advantage that spreading can be realized by simply rotating the cam. As a result, a transmission of the drive unit can be purely rotatory. Through the cam, complex and expensive elements for rotation-translation conversion can be dispensed with.

In a further advantageous embodiment of the present invention, an adjustment path of the cam is designed in such a way that it includes wear of the brake shoes. Through such a design of the cam, a separate device for wear readjustment can be dispensed with. The complexity of the electromechanical drum brake can thereby be reduced. The weight on the unsprung wheel can also be reduced. Overall, such an electromechanical drum brake can be produced more economically as a result. In addition, it is possible to adjust the air gap of the brake as desired depending on the driving state in order to minimize losses due to residual drag in every situation and to achieve sufficient response dynamics of the brake.

According to a further expedient embodiment of the present invention, the drive unit comprises a transmission unit, which is designed without locking. The transmission unit thus has no self-locking. After braking, the brake pads can be automatically released again via the expansion clip by the forces occurring in the drum. This makes it possible to open the brake in a currentless state, such as a fault state. As a result, such an electromechanical drum brake can also be used as a service brake in a passenger vehicle.

Preferably, according to an example embodiment of the present invention, the drive unit comprises a transmission unit comprising at least one worm and spur gear stage. Such a worm and spur gear stage has a high gear ratio while requiring a small installation space. As a result, a drive unit with such a worm and spur gear stage can be used in the area of the rim.

Exemplary embodiments of the present invention are shown in the figures and explained in more detail in the following description.

### BRIEF DESCRIPTION OF THE DRAWINGS

FIG. 1 shows a schematic illustration of an electromechanical drum brake according to an exemplary embodiment of the present invention.

FIG. 2 shows a plan view of an internal arrangement in a drum according to an exemplary embodiment of the present invention.

FIG. 3 shows a sectional view in the area of the cam of the electromechanical drum brake according to FIG. 2.

FIG. 4 shows a support bearing according to an exemplary embodiment of the present invention.

### DETAILED DESCRIPTION OF EXAMPLE EMBODIMENTS

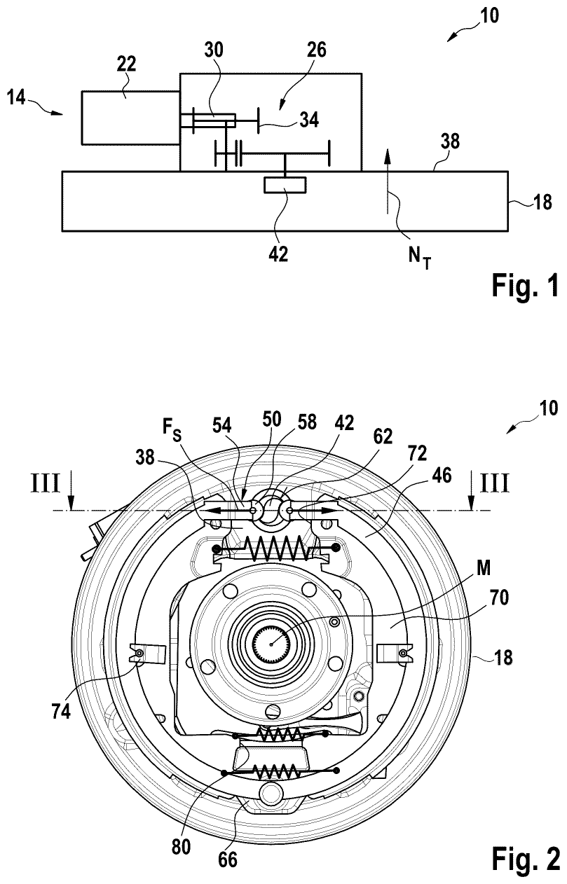

FIG. 1 shows a schematic illustration of an electromechanical drum brake 10 according to an exemplary embodiment of the present invention. The electromechanical drum brake 10 comprises a drive unit 14 and a drum 18. The drive unit 14 comprises an electric motor 22, which drives a transmission unit 26. The transmission unit 26 comprises a worm 30, which is driven by the electric motor 22 and which drives multiple spur gears 34 of the transmission unit 26. The drive unit 14 is attached to a rear wall 38 of the drum 18. An adjusting device 42 arranged in the drum 18 is driven via the spur gears 34.

FIG. 2 shows a plan view of an internal arrangement in a drum 18 according to an exemplary embodiment of the present invention. In this view, the drum 18 has been omitted for a better view. The figure also shows the adjusting device 42, which is designed as an S-shaped cam in this exemplary embodiment. The cam 42 cooperates with two support means 46, which are designed as expansion clips in this exemplary embodiment. In this exemplary embodiment, the expansion clips 46 are semi-annular. On each expansion clip end 50 facing the cam 42 is arranged a roller carrier 54, to which a roller 58 cooperating with the cam 42 is attached. The roller 58 rolls on a surface 62 of the cam 42 and thus follows the contour of the cam 42.

At their ends opposite to the cam 42, the expansion clips 46 are rotatably supported on a support bearing 66. Rotation of the cam 42 causes the expansion clips 46 to perform a rotational movement about the support bearing 66 in an area of the cam 42. Accordingly, the expansion clips 46 are spread by a rotation of the cam 42. By the spreading movement, the expansion clips 46 apply a spreading force Fₛ to brake shoes 70 arranged in the drum 18. The spreading force Fₛ is applied to an end 72 of the brake shoes 70 that faces the adjusting device 42. This end 72 of the brake shoes is movably supported on the expansion clips 46. Accordingly, for braking, the brake shoes 70 are placed against the drum 18.

Between a center point M of the drum 18 and the expansion clips 46, a respective holding element 74, via which the brake shoes 70 are held in a normal direction N_{T} (see FIG. 1) of the drum 18, is arranged on the brake shoes 70. This prevents the brake shoes from moving in the normal direction N_{T} within the drum. In the exemplary embodiment shown here, the holding elements 74 are designed as retaining clips. The holding elements 74 only abut against the expansion clips 46. This ensures relative mobility of the brake shoes 70 in relation to the expansion clips 46.

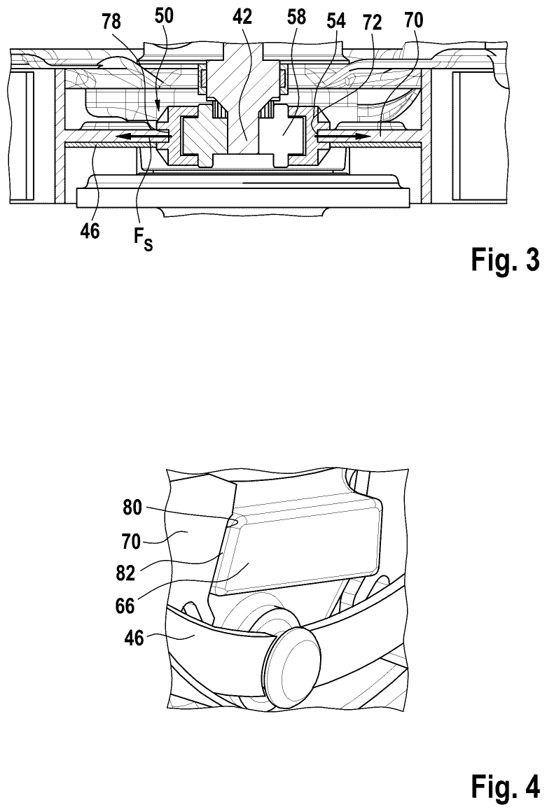

FIG. 3 shows a sectional view in the area of the cam 42 of the electromechanical drum brake 10 of FIG. 2. In this figure, it can be seen how the cam 42 acts on the expansion clips 46 via the rollers 58. At an expansion clip end 50 facing the adjusting device 42, the expansion clips 46 form an upper stop 78 for the brake shoes 70. The brake shoes 70 are only supported on the respective upper stop 78 and are thus movably mounted in the area of the upper stop 78. Via this upper stop 78, the spreading force Fₛ can thus also be applied to the brake shoes 70 via the expansion clips 46.

FIG. 4 shows the support bearing 66 according to an exemplary embodiment of the present invention. At an end 80 of the brake shoes 70 that is opposite to the adjusting device 42, this support bearing 66 forms a lower stop 82 for the brake shoes 70. The brake shoes 70 are also only supported on the lower stop 82 so that the brake shoes are movable in relation to the lower stop 82. Accordingly, the brake shoes 70 only abut against the lower and upper stops 78, 82 so that the brake shoes 70 are not fixed in the drum 18 and can move. As a result, it is possible that out-of-roundness and eccentricity of the drum brake 10 can be compensated. A possibility of compensation in the area of the cam 42 can thus be dispensed with.

What is claimed is:

1. An electromechanical drum brake for a motor vehicle, comprising:
a drum, in which brake shoes are arranged; and
an adjusting device, which is arranged between the brake shoes and driven by a drive unit and via which the brake shoes can be spread for braking;
wherein an end of each of the brake shoes that faces the adjusting device is supported on a support arrangement cooperating with the adjusting device, movably in relation to the support arrangement, wherein a spreading force of the adjusting device is transferable to the brake shoes via the support arrangement.

2. The electromechanical drum brake according to claim 1, wherein a support bearing, on which the brake shoes are movably supported, is arranged at an end of the brake shoes that is opposite to the adjusting device.

3. The electromechanical drum brake according to claim 1, wherein the support arrangement includes semi-annular expansion clips.

4. The electromechanical drum brake according to claim 3, wherein a support bearing, on which the expansion clips are rotatably supported, is arranged at an end of the brake shoes that is opposite to the adjusting device.

5. The electromechanical drum brake according to claim 3, wherein at least one holding element, which cooperates with a corresponding expansion clip and via which the brake shoes can be held in a normal direction of the drum, is attached to the brake shoes.

6. The electromechanical drum brake according to claim 5, wherein the holding element is a retaining clip.

7. The electromechanical drum brake according to claim 3, wherein the adjusting device including a cam, and wherein, at an expansion clip end facing the cam, the expansion clips respectively include a roller carrier, on which a roller is arranged, which is in contact with the cam.

8. The electromechanical drum brake according to claim 1, wherein the adjusting device is an S-shaped cam.

9. The electromechanical drum brake according to claim 8, wherein an adjustment path of the cam is configured in such a way that the adjustment path includes wear of the brake shoes.

10. The electromechanical drum brake according to claim 1, wherein the drive unit includes a transmission unit, which is configured without locking.
